(19) United States
(12) Patent Application Publication
(10) Pub. No.: US 2026/0025316 A1
(43) Pub. Date: Jan. 22, 2026

(54) METHOD, APPARATUS AND COMPUTER PROGRAM

(71) Applicant: Nokia Technologies Oy, Espoo (FI)

(72) Inventors: Anna PANTELIDOU, Massy (FR); Konstantinos SAMDANIS, Munich (DE); Shu Qiang SUN, Chengdu (CN)

(21) Appl. No.: 18/997,996

(22) PCT Filed: Aug. 5, 2022
(86) PCT No.: PCT/CN2022/110542

§ 371 Date: Jan. 23, 2025

(51) Int. Cl. H04L 41/14

(52) U.S. Cl. CPC H04L 41/14

(57) ABSTRACT

There is provided an apparatus comprising means for: receiving, at a first data analytics function from a second data analytics function, configuration information for obtaining a first set of analytics, wherein the configuration information comprises a triggering condition for reporting the first set of analytics, wherein the first analytics function is configured to utilise a first set of input data for obtaining the first set of analytics and the second analytics function is configured to utilise a second set of input data for obtaining the second set of analytics; based on the configuration information, obtaining the first set of analytics based on the first set of input data; determining that the triggering condition is satisfied; and in response to determining that the triggering condition is satisfied, sending, to the second data analytics function, the first set of analytics.

### FIELD

The present application relates to a method, apparatus, system and computer program and in particular but not exclusively to obtaining at least two sets of analytics of different scope.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite-based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

According to an aspect, there is provided an apparatus comprising means for: receiving, at a first data analytics function from a second data analytics function, configuration information for obtaining a first set of analytics, wherein the configuration information comprises a triggering condition for reporting the first set of analytics, wherein the first analytics function is configured to utilise a first set of input data for obtaining the first set of analytics and the second analytics function is configured to utilise a second set of input data for obtaining the second set of analytics; based on the configuration information, obtaining the first set of analytics based on the first set of input data; determining that the triggering condition is satisfied; and in response to determining that the triggering condition is satisfied, sending, to the second data analytics function, the first set of analytics.

The means may be for: receiving, from the second data analytics function, the second set of analytics, wherein determining that a triggering condition is satisfied comprises determining that a difference between the first set of analytics and the second set of analytics is greater than a threshold.

The difference may comprise a deviation value.

The means may be for: receiving, from the second data analytics function and in response to sending the first set of analytics, one or more policies.

According to an aspect, there is provided an apparatus comprising means for: sending, from a second analytics function to a first data analytics function, configuration information for causing the first data analytics function to obtain a first set of analytics, wherein the configuration information comprises a triggering condition for reporting the first set of analytics, wherein the second analytics function is configured to utilise a second set of input data for obtaining a second set of analytics and the first analytics function is configured to utilise a first set of input data for obtaining the first set of analytics; in response to the triggering condition being satisfied, receiving, from the first data analytics function, the first set of analytics; obtaining a second set of analytics based on the second set of input data; and determining one or more policies based on the first set of analytics and the second set of analytics.

The means may be for: sending, to the first data analytics function, the second set of analytics when sending the configuration information, wherein the triggering condition comprises that a difference between the first set of analytics and the second set of analytics is greater than a threshold.

Obtaining the second set of analytics may be further based on the first set of analytics.

The means may be for: determining that a difference between the first set of analytics and the second set of analytics is greater than a threshold; and determining the one or more policies in response to determining that the difference between the first set of analytics and the second set of analytics is greater than the threshold.

The configuration information may comprise information identifying at least one of: the first set of analytics; further analytics related to the first set of analytics; one or more target objects associated with the first set of analytics; an area of interest associated with the first set of analytics; and timing information associated with the first set of analytics.

The first set of analytics may comprise a prediction.

The first data analytics function and/or the second data analytics function may comprise one of: a management data analytics function; a network data analytics function; an operations administration and management function; and a radio data analytics function.

According to an aspect, there is provided an apparatus comprising at least one processor and at least one memory including a computer program code, the at least one memory and computer program code configured to, with the at least one processor, cause the apparatus at least to: receive, at a first data analytics function from a second data analytics function, configuration information for obtaining a first set of analytics, wherein the configuration information comprises a triggering condition for reporting the first set of analytics, wherein the first analytics function is configured to utilise a first set of input data for obtaining the first set of analytics and the second analytics function is configured to utilise a second set of input data for obtaining the second set of analytics; based on the configuration information, obtain the first set of analytics based on the first set of input data; determine that the triggering condition is satisfied; and in response to determining that the triggering condition is satisfied, send, to the second data analytics function, the first set of analytics.

The at least one memory and at least one processor may be configured to cause the apparatus to: receive, from the second data analytics function, the second set of analytics, wherein he at least one memory and at least one processor may be configured to cause the apparatus to determine that a triggering condition is satisfied by determining that a difference between the first set of analytics and the second set of analytics is greater than a threshold.

The difference may comprise a deviation value.

The at least one memory and at least one processor may be configured to cause the apparatus to: receive, from the second data analytics function and in response to sending the first set of analytics, one or more policies.

According to an aspect, there is provided an apparatus comprising at least one processor and at least one memory including a computer program code, the at least one memory and computer program code configured to, with the at least one processor, cause the apparatus at least to: send, from a second analytics function to a first data analytics function, configuration information for causing the first data analytics function to obtain a first set of analytics, wherein the configuration information comprises a triggering condition for reporting the first set of analytics, wherein the second analytics function is configured to utilise a second set of input data for obtaining a second set of analytics and the first analytics function is configured to utilise a first set of input data for obtaining the first set of analytics; in response to the triggering condition being satisfied, receive, from the first data analytics function, the first set of analytics; obtain a second set of analytics based on the second set of input data; and determine one or more policies based on the first set of analytics and the second set of analytics.

The at least one memory and at least one processor may be configured to cause the apparatus to: send, to the first data analytics function, the second set of analytics when sending the configuration information, wherein the triggering condition comprises that a difference between the first set of analytics and the second set of analytics is greater than a threshold.

The at least one memory and at least one processor may be configured to cause the apparatus to obtaining the second set of analytics further based on the first set of analytics.

The at least one memory and at least one processor may be configured to cause the apparatus to: determine that a difference between the first set of analytics and the second set of analytics is greater than a threshold; and determine the one or more policies in response to determining that the difference between the first set of analytics and the second set of analytics is greater than the threshold.

The configuration information may comprise information identifying at least one of: the first set of analytics; further analytics related to the first set of analytics; one or more target objects associated with the first set of analytics; an area of interest associated with the first set of analytics; and timing information associated with the first set of analytics.

The first set of analytics may comprise a prediction.

The first data analytics function and/or the second data analytics function may comprise one of: a management data analytics function; a network data analytics function; an operations administration and management function; and a radio data analytics function.

According to an aspect, there is provided a method comprising: receiving, at a first data analytics function from a second data analytics function, configuration information for obtaining a first set of analytics, wherein the configuration information comprises a triggering condition for reporting the first set of analytics, wherein the first analytics function is configured to utilise a first set of input data for obtaining the first set of analytics and the second analytics function is configured to utilise a second set of input data for obtaining the second set of analytics; based on the configuration information, obtaining the first set of analytics based on the first set of input data; determining that the triggering condition is satisfied; and in response to determining that the triggering condition is satisfied, sending, to the second data analytics function, the first set of analytics.

The method may comprise: receiving, from the second data analytics function, the second set of analytics, wherein determining that a triggering condition is satisfied comprises determining that a difference between the first set of analytics and the second set of analytics is greater than a threshold.

The difference may comprise a deviation value.

The method may comprise: receiving, from the second data analytics function and in response to sending the first set of analytics, one or more policies.

According to an aspect, there is provided a method comprising: sending, from a second analytics function to a first data analytics function, configuration information for causing the first data analytics function to obtain a first set of analytics, wherein the configuration information comprises a triggering condition for reporting the first set of analytics, wherein the second analytics function is configured to utilise a second set of input data for obtaining a second set of analytics and the first analytics function is configured to utilise a first set of input data for obtaining the first set of analytics; in response to the triggering condition being satisfied, receiving, from the first data analytics function, the first set of analytics; obtaining a second set of analytics based on the second set of input data; and determining one or more policies based on the first set of analytics and the second set of analytics.

The method may comprise: sending, to the first data analytics function, the second set of analytics when sending the configuration information, wherein the triggering condition comprises that a difference between the first set of analytics and the second set of analytics is greater than a threshold.

Obtaining the second set of analytics may be further based on the first set of analytics.

The method may comprise: determining that a difference between the first set of analytics and the second set of analytics is greater than a threshold; and determining the one or more policies in response to determining that the difference between the first set of analytics and the second set of analytics is greater than the threshold.

The configuration information may comprise information identifying at least one of: the first set of analytics; further analytics related to the first set of analytics; one or more target objects associated with the first set of analytics; an area of interest associated with the first set of analytics; and timing information associated with the first set of analytics.

The first set of analytics may comprise a prediction.

The first data analytics function and/or the second data analytics function may comprise one of: a management data analytics function; a network data analytics function; an operations administration and management function; and a radio data analytics function.

According to an aspect, there is provided a computer readable medium comprising program instructions for causing an apparatus to perform at least the following: receiving, at a first data analytics function from a second data analytics function, configuration information for obtaining a first set of analytics, wherein the configuration information comprises a triggering condition for reporting the first set of analytics, wherein the first analytics function is configured to utilise a first set of input data for obtaining the first set of analytics and the second analytics function is configured to utilise a second set of input data for obtaining the second set of analytics; based on the configuration information, obtaining the first set of analytics based on the first set of input data; determining that the triggering condition is satisfied; and in response to determining that the triggering condition is satisfied, sending, to the second data analytics function, the first set of analytics.

The program instructions may be for causing the apparatus to further perform: receiving, from the second data analytics function, the second set of analytics, wherein determining that a triggering condition is satisfied comprises determining that a difference between the first set of analytics and the second set of analytics is greater than a threshold.

The difference may comprise a deviation value.

The program instructions may be for causing the apparatus to further perform: receiving, from the second data analytics function and in response to sending the first set of analytics, one or more policies.

According to an aspect, there is provided a computer readable medium comprising program instructions for causing an apparatus to perform at least the following: sending, from a second analytics function to a first data analytics function, configuration information for causing the first data analytics function to obtain a first set of analytics, wherein the configuration information comprises a triggering condition for reporting the first set of analytics, wherein the second analytics function is configured to utilise a second set of input data for obtaining a second set of analytics and the first analytics function is configured to utilise a first set of input data for obtaining the first set of analytics; in response to the triggering condition being satisfied, receiving, from the first data analytics function, the first set of analytics; obtaining a second set of analytics based on the second set of input data; and determining one or more policies based on the first set of analytics and the second set of analytics.

The program instructions may be for causing the apparatus to further perform: sending, to the first data analytics function, the second set of analytics when sending the configuration information, wherein the triggering condition comprises that a difference between the first set of analytics and the second set of analytics is greater than a threshold.

Obtaining the second set of analytics may be further based on the first set of analytics.

The program instructions may be for causing the apparatus to further perform: determining that a difference between the first set of analytics and the second set of analytics is greater than a threshold; and determining the one or more policies in response to determining that the difference between the first set of analytics and the second set of analytics is greater than the threshold.

The configuration information may comprise information identifying at least one of: the first set of analytics; further analytics related to the first set of analytics; one or more target objects associated with the first set of analytics; an area of interest associated with the first set of analytics; and timing information associated with the first set of analytics.

The first set of analytics may comprise a prediction.

The first data analytics function and/or the second data analytics function may comprise one of: a management data analytics function; a network data analytics function; an operations administration and management function; and a radio data analytics function.

According to an aspect, there is provided a non-transitory computer readable medium comprising program instructions for causing an apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a representation of a network system according to some example embodiments;

FIG. 2 shows a representation of a control apparatus according to some example embodiments;

FIG. 3 shows a representation of an apparatus according to some example embodiments;

FIG. 4 shows an example management data analytics framework;

FIG. 5 shows methods according to some examples; and

FIGS. 6 to 8 show processes according to some examples.

### DETAILED DESCRIPTION

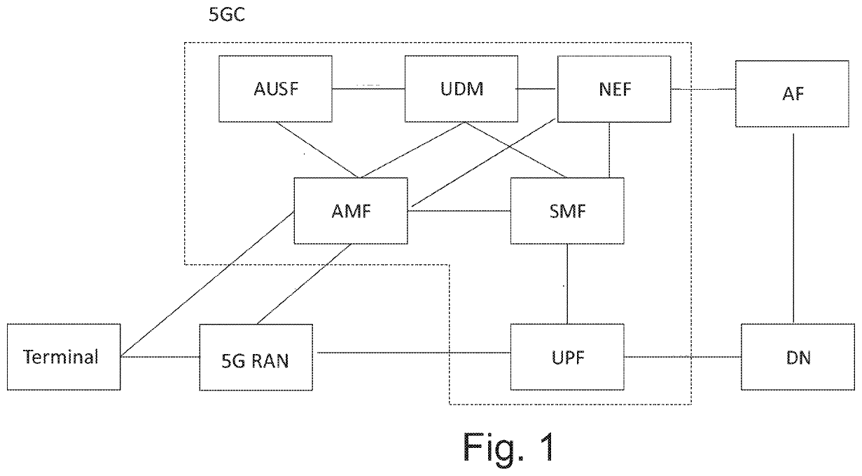

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may be comprised by a terminal or user equipment (UE), a 5G radio access network (5GRAN) or next generation radio access network (NG-RAN), a 5G core network (5GC), one or more application function (AF) and one or more data networks (DN).

The 5G-RAN may comprise one or more gNodeB (gNB) or one or more gNodeB (gNB) distributed unit functions connected to one or more gNodeB (gNB) centralized unit functions. The 5GC may comprise the following entities: Network Slice Selection Function (NSSF); Network Exposure Function; Network Repository Function (NRF); Policy Control Function (PCF); Unified Data Management (UDM); Application Function (AF); Authentication Server Function (AUSF); an Access and Mobility Management Function (AMF); and Session Management Function (SMF).

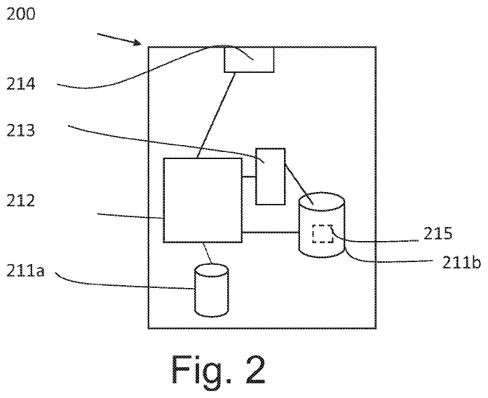

FIG. 2 illustrates an example of a control apparatus 200 for controlling a function of the 5GRAN or the 5GC as illustrated on FIG. 1. The control apparatus may comprise at least one random access memory (RAM) 211a, at least one read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5GRAN or the 5GC. In some embodiments, each function of the 5GRAN or the 5GC comprises a control apparatus 200. In alternative embodiments, two or more functions of the 5GRAN or the 5GC may share a control apparatus.

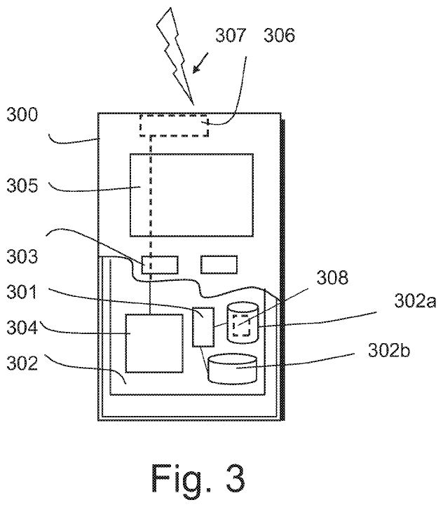

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

In some examples, Artificial Intelligence (AI)/Machine Learning (ML) techniques may be implemented in wireless networks to enhance network operations and optimize network performance.

In some implementations, a Management Data Analytics (MDA) Management Service (MnS) producer may perform both AI/ML Inference and AI/ML Training (which may help protect AI/ML model internal implementations across vendors). The MDA MnS may consume various types of data, which can include performance measurements as per the 3GPP TS 28.552, Key Performance Indicators (KPIs) as per 3GPP TS 28.554 and trace data, including Minimization of Drive Tests (MDT), Radio Link Failure (RLF), and Radio Connection Establishment Failure (RCEF), as per 3GPP TS 32.422 and 3GPP TS 32.423.

AI/ML model training may be requested by a MDA MnS consumer. For example, the MDA MnS consumer may send a training request to an AI/ML Model training coordinator requesting the model training.

The AI/ML Model training coordinator (also called as MDA MnS consumer) may decide when such training shall take place, what input data the model shall consume, the scope of training (e.g., in terms of numeric range or other related attributes) and which MDA MnS producers shall execute the training.

In the training request, the MDA MnS consumer may provide the type of the AI/ML model and the type of analytics, (i.e., what purpose it serves—for example, resolve coverage issues) and the required AI/ML model performance (e.g., in terms of accuracy). The MDA MnS consumer may optionally provide the data sources or other data for the training performed by the MDA MnS producer. In some examples, the MDA MnS producer may decide to use other sources of data.

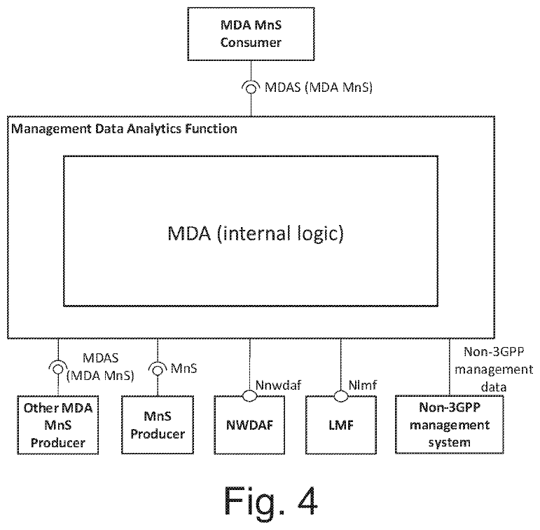

A functional framework for the MDA, as defined in 3GPP TS 28.104, and its relation to Network Data Analytics Function (NWDAF) is illustrated as shown in FIG. 4.

In the example shown in FIG. 4, a management function (such as a Management Data Analytics Function, MDAF) may play the roles of MDA MnS producer, MDA MnS consumer, NWDAF consumer and LMF service consumer.

An MDA, or more generally a data analytics function, can obtain information from NWDAF, for example analytics that relate to 5GC data. Analytics from MDA can also become available at authorized consumers, including NWDAF.

For instance, the MDA can obtain analytics from the NWDAF relating to network slice load and perform network slice load analysis. The MDA may then provide an output of the network slice load analysis back to the NWDAF. For example, the output may include slice load level related network data analytics and analytics for user plane performance (i.e., average/maximum traffic rate, average/maximum packet delay, average packet loss rate, and related predictions results).

In a further example, MDA assisted energy saving may utilize network analytics data from NWDAF in the input, e.g., observed service experience related analytics, to provide an output comprising statistics on the energy saving state of cells at a given time. This information can be used to decide when to enter or exit energy saving state based on the current state.

The use of analytics may have a distinct operating scope in terms of the analytics type, the range of input data, objects involved, time scale, specific analytics context (e.g., UE profile, area of interest), etc.

MDA and RAN analytics may operate separately, i.e., there may be no interworking between MDA and RAN analytics in neither the inference nor the training phase. This may result in sub-optimal inference or training, as not all the available information may be being utilized.

Some aspects of the present disclosure may use a combination of analytics which have a different operating scope. As an example, some aspects may combine the output results of MDA and RAN analytics, or the output results of NWDAF and RAN or the output results of NWDAF with OAM, in order to enhance the insight with more specific details. It should be understood that other combinations of analytics (e.g. NWDAF, RAN etc.) not explicitly given here may also fall within the scope of the present disclosure.

The MDA may provide analytics based on predictions it produces or based on predictions that it receives externally e.g., from a gNB.

The OAM and RAN may have different views of the network and may operate in different timescales. The same situation may hold for the case of combining analytics between the NWDAF and RAN as well as for the case of NWDAF and OAM.

For example, in RAN, the received information may be considered to be more “real-time” as opposed to OAM which may be considered as “non real-time”, but over a much longer duration. Similarly for the case of NWDAF the received information may be related to particular UEs as opposed to OAM which may obtain information based on an average number of UEs in a particular cell or area of interest.

These different time-scales and scope in the predictions may account to very different results, and may make interworking more challenging.

In addition, OAM may be in control of a large number of gNBs or Network Functions (NFs) and may have a broader view of the network. The OAM may configure management-based procedures towards the RAN or 5G core to collect information over a PLMN, over a list of cells provided in the area scope, over a Routing Area (RA), Tracking Area (TA), etc.

Receiving this information, the OAM may calculate predictions through averaging of the received measurements from the RAN or 5G core. RAN on the other hand may collect real-time information and NWDAF may collect UE information that cannot be collected in this rate by the OAM.

In combining RAN or 5G core and OAM analytics or RAN and 5G core analytics, one problem is how one domain would know the type of analytics, the scope and transport method as elaborated below:
The type of analytics may include not only a single attribute, e.g., radio load, but also other related attributes, e.g., mobility;
Depending on the target objects and their characteristics, e.g., UEs with high or low mobility, there may be a need to select the operational scope, i.e., area of interest or slice or even select specific NFs (i.e., DNs); and.
Depending on the need of analytics exchange among the two domains the transport mechanism can be selected, i.e., real-time versus non-real-time.

The two predictions (i.e., MDA and RAN analytics or MDA and NWDAF or RAN and NWDAF) may be very different. This can happen if for instance the area on which OAM calculates a load prediction comprises of very different gNBs or NFs with respect to their load.

To be able to better utilize predictions from RAN, 5G core and OAM, it may be desirable for the OAM to “compare” and “correlate” OAM and RAN or 5G core related analytics and enhance reporting mechanisms in order to capture the deviation and the related context so the consumer can gain a better understanding.

In some examples, this may be achieved by comparing the prediction of, e.g., the RAN and OAM or vice versa, taking advantage of the data collected to learn the patterns of deviation, i.e., how the prediction diverge from different sources (e.g., RAN and OAM).

In some examples, the measurements may be modeled as “time series data” and the analytics of “time series data” may be used to learn patterns of time periods/seasonality or trends, etc. There may be different types of time period patterns, e.g., daily, weekly, monthly, seasonally, annually, etc.

A RAN node may collect finer granularity data for short duration. The finer granularity time period pattern may be well captured in a timely manner, while the OAM with longer range of data (which is more aggregated) will more accurately capture the higher granularity level of time period patterns.

Hence, combing the analytics results from RAN, 5G core and OAM or between RAN and 5G core may improve the accuracy for overall predictions.

On another matter, the data collected from one RAN or 5G core node may be biased for that specific RAN node or NF, which may imply that the prediction with the data learned and inferred may tend to be biased for that specific node.

On the other hand, the OAM may collect data of longer range and from a large amount of different RAN nodes or NFs, which as a consequence may imply that the prediction may be unbiased towards the overall RAN nodes or 5G core area.

Hence combining the results from both the RAN or 5G core and OAM, or between NWDAF and RAN may also improve the overall prediction accuracy and may mitigate some bias in the prediction.

Data analytics and AI/ML may be implemented in various part of the 5G System. For example, in the 5G core, the NWDAF may provide statistics and predictions e.g., user mobility, communications patterns, etc., focusing on the user and control plane (as per 3GPP TS 23.288). In the management plane, the Management Data Analytics (MDA) may provide statistics, predictions and recommendations related to resource allocation, fault management and network optimization (as per 3GPP TS 28.104). In the access node, RAN analytics may provide real-time predictions to assist the scheduling process and also explore AI/ML workflow (as per 3GPP TR 37.817).

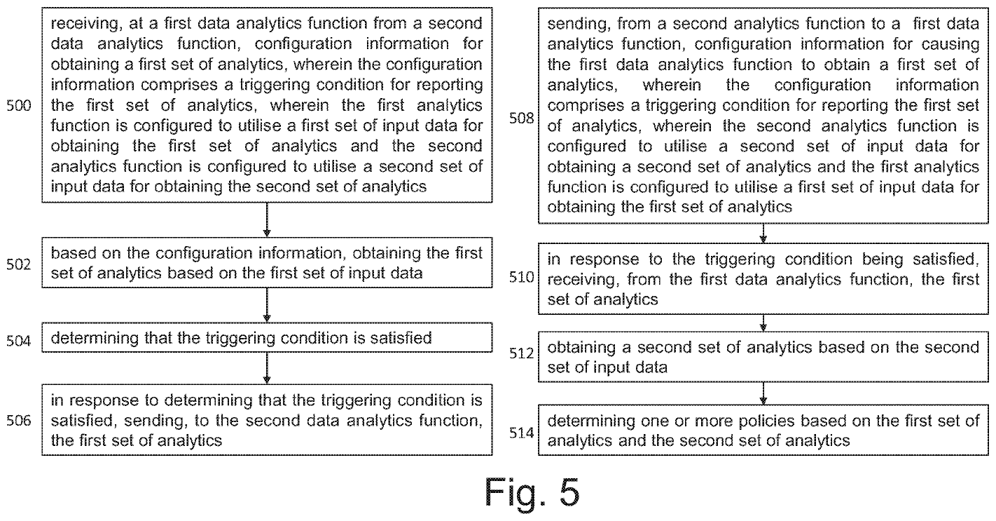

Reference is made to FIG. 5, which shows methods according to some examples.

At 500, a method comprises receiving, at a first data analytics function from a second data analytics function, configuration information for obtaining a first set of analytics, wherein the configuration information comprises a triggering condition for reporting the first set of analytics, wherein the first analytics function is configured to utilise a first set of input data for obtaining the first set of analytics and the second analytics function is configured to utilise a second set of input data for obtaining the second set of analytics.

At 502, the method comprises, based on the configuration information, obtaining the first set of analytics based on the first set of input data.

At 504, the method comprises determining that the triggering condition is satisfied.

At 506, the method comprises, in response to determining that the triggering condition is satisfied, sending, to the second data analytics function, the first set of analytics.

At 508, a method comprises sending, from a second analytics function to a first data analytics function, configuration information for causing the first data analytics function to obtain a first set of analytics, wherein the configuration information comprises a triggering condition for reporting the first set of analytics, wherein the second analytics function is configured to utilise a second set of input data for obtaining a second set of analytics and the first analytics function is configured to utilise a first set of input data for obtaining the first set of analytics;

At 510, the method comprises, in response to the triggering condition being satisfied, receiving, from the first data analytics function, the first set of analytics.

At 512 the method comprises obtaining a second set of analytics based on the second set of input data.

At 514, the method comprises determining one or more policies based on the first set of analytics and the second set of analytics.

Some aspects of the present disclosure may provide a method allowing a first data analytics function (e.g., Management Data Analytics Function (MDAF) or Network Data Analytics Function (NWDAF)) to compare and correlate the obtained analytics with other network entities (for example a second data analytics function) that have a different view of the data analytics—for example other network entities may operate over a different time scale compared to the first data analytics function (e.g. hourly vs. daily analytics) or have a different range of source data (e.g. data coming from RAN or from even a smaller area).

In some examples, a first data analytics function (e.g. MDAF or NWDAF) may compare and correlate obtained management plane analytics with the ones received from a second data analytics function (e.g. MDAF, NWDAF, or radio analytics function). As used herein, in some examples the analytics may comprise a prediction, such as a prediction provided by an AI/ML model.

For example, a MDAF may obtain analytics from a radio analytics function, and compare the obtained analytics to analytics produced by the MDAF. Likewise the radio analytics function may compare and correlate radio analytics with analytics received from the management data analytics function.

Similarly, the NWDAF and MDA could compare and correlate the obtained analytics from each other, since one focuses on the control plane or is user centric and the other handles network analytics related to, e.g., resource allocation, faults, etc.

In some examples, the comparison and correlation may comprise utilizing the deviation, e.g., standard deviation, between the predictions calculated from the first data analytics function and the predictions received from the second data analytics function.

Based on this correlation, in some examples an insight may be obtained by identifying gNBs that are far away from an average/mean available at the first data analytics function.

In some examples, a broader view around specific gNBs may be obtained since the first data analytics function may calculate analytics based on a broader area than a RAN analytics function which provides analytics on a per gNB basis (or even finer granularity e.g., gNB-CU, gNB-DU, etc.).

In some examples, the comparison and correlation may comprise utilizing the deviation, e.g., standard deviation, between the predictions calculated from the first data analytics function (e.g. MDAF) and the predictions received from the second data analytics function (e.g. NWDAF or RAN analytics function.

To be able to obtain meaningful analytics for comparison there may be need for a configuration of a triggering policy, i.e., when a result is needed from the first data analytics function to be provided to the second data analytics function.

The triggering policy may comprise a moving threshold (i.e., a threshold that changes depending on the expected distances) determining that the analytics (e.g., a prediction) provided by the first data analytics function (e.g. RAN, or NWDAF) exceeds a certain value by more than a threshold amount.

The certain value may correspond to the analytics available at the second data analytics function (e.g. the OAM, MDA). That is to say, if the difference between the analytics obtained by the first data analytics function differs from the analytics provided by the second data analytics function by more than a certain amount, the triggering condition may be satisfied.

The triggering policy may trigger the second data analytics function to provide further analytics to the first data analytics function. In this way, a first data analytics function may identify several entities (e.g., gNBs) that behave outside the expected average (e.g., they exceed predicted OAM load by a given threshold).

From the RAN perspective, a similar moving threshold can be applied for the average or broader scope analytics. In addition RAN analytics can also select the area of interest for obtaining analytics from a data analytics function based on the UE types of interest and mobility profile, e.g., IoT or mobile user with high, medium, low mobility profile.

The triggering conditions can be a part of an analytics request. This may be particularly useful for MDA since there is currently no method at OAM level to uniquely identify a UE.

The triggering policy may alternatively comprise a moving threshold determining that the prediction calculated by a data analytics function (MDA in OAM or NWDAF in the network) exceeds a configurable certain value, corresponding to the prediction available at a different data analytics function, by a threshold.

The configuration for analytics may include the area scope (e.g. geographical area of interest), time window of interest (start time/end time of predictions), and a set of configured analytics. In some examples, the set of configured analytics may be indicated implicitly or explicitly. In some examples, if a certain analytic is requested, other analytics considered as relevant may be also sent along by the gNB.

The following attributes may be defined to capture the configuration:
The requested analytics (analytics type, name, list of analytics values or output, time intervals, confidence degree);
The related analytics, which can be in the form of related analytics type name, list of analytics values or output, time intervals, confidence degree;
The target objects, e.g., gNBs, and related characteristics;
Area of interest, geographical area or TA/LA/RAs or a non-public network identifier, e.g., CAG-ID; and.
Information type, e.g. real-time, non-real-time, or defining the expected time

Output analytics may be statistics and/or predictions which when provided by the RAN allow OAM to process them and still obtain a useful result.

Once the consumer obtains these analytics results, the consumer may make a more accurate decision. For example, the OAM may disable offloading actions to gNBs whose load exceeds the OAM calculated average load by a threshold value. Furthermore, the OAM may configure an energy saving policy to those gNBs whose energy efficiency is less than a second threshold compared to the energy efficiency prediction calculated by MDAs. In this way MDAs can configure different policies to RAN (gNBs) that depend on how far the local real-time predictions in the RAN are compared to the OAM related ones.

The following description below focuses on examples considering analytics in the RAN and MDA in the OAM. However it should be understood that the same mechanisms and similar sequence diagrams can be also applied for other cases, such as for the case of MDA and NWDAF as well as for the case of RAN analytics and NWDAF.

Some examples introduce a method for combining MDA and RAN analytics for enhancing analytics performance in either RAN or OAM. To accomplish this, some examples may comprise selecting:
(i) One or more gNBs from which the MDA requests analytics to enhance MDA; and/or
(ii) One or more areas of interest from which a gNB requests broader analytics view to enhance RAN analytics.

Therefore in some examples specific triggering conditions may be utilized to specify when and from where, i.e., which network part, analytics shall be obtained.

In some examples, a MDAS producer (also called MDA MnS producer) may calculate analytics locally. The MDAS producer may be located in the core network.

For example the MDAS producer may calculate a predicted load over a number of cells considering input data from gNB performance measurements. The MDAS producer can utilize information based on a large geographical area comprising a plurality of gNBs (and cells).

The MDAS producer may also create an analytics job for obtaining analytics from one or more other network entities, such as one or more gNBs.

The analytics job may indicate the entities (e.g., cells) that need to be involved, the duration period that can be explicitly specified or may start immediately until instructed to stop, and other triggering conditions, e.g., when a deviation surpasses a certain difference limit (threshold).

The triggering conditions may contain a threshold or network state, which depend on a particular analytic type. Depending on the requested analytics, (e.g., prediction), other analytics may be additionally appended in the response message. The other analytics may be other predictions related to the original analytics request, e.g., if the radio load is requested from a gNB then the mobility rates towards neighboring gNBs may also be needed, in order to gain knowledge of the future load and related variations.

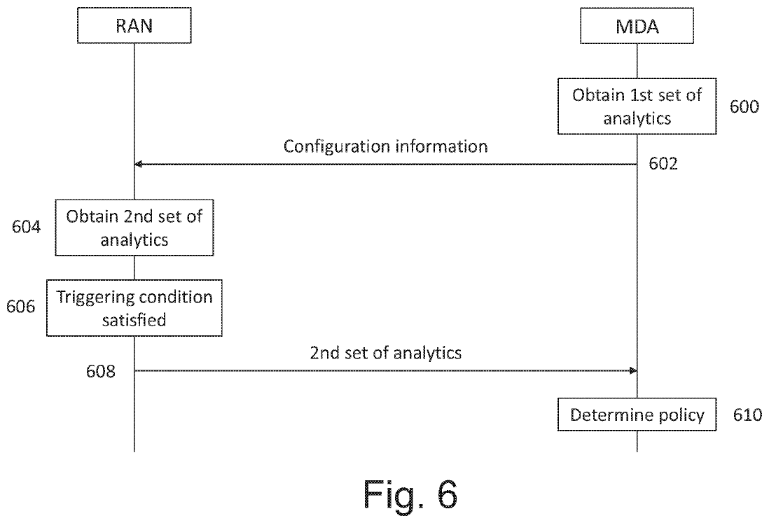

Reference is made to FIG. 6, which shows a process according to some examples.

At 600, the MDA (a first data analytics function) obtains a first set of analytics based on a first set of data available at the MDAS. The first set of analytics may comprise a set of predicted PRB usage.

At 602, the MDA sends configuration information to the RAN. The configuration information may be based on the first set of analytics. The configuration information may comprise information indicating one or more of:
An area scope (for example one or more cells/TAs/RAs) for obtaining analytics on;
A time period which the analytics are to be obtained for;
At least one tiggering condition (for example the prediction from the MDA and a threshold); and
That other analytics information is enabled.

In some examples, the MDA may also send the first set of analytics to the RAN in step 602.

The Area scope (cells/TA/RA) may represent a Management Object or a group of Management Objects (MO), i.e. one or more MOs. It should be noted that RAN in FIG. 6 may represent multiple RANs.

At 604, based on the configuration information received at 602, a radio analytics function (a second analytics function) at the RAN obtains a second set of analytics.

At 606, the RAN determines, based on the obtained second set of analytics, whether the at least one triggering condition is satisfied. For example, the RAN may determine whether the second set of analytics (e.g., PRB usage predicted at the RAN) differs from the first set of analytics (e.g., PRB usage predicted at the MDA) by more than the threshold amount. It should be understood that in some examples other triggering conditions may be used.

At 608, responsive to determining that the at least one triggering condition is satisfied, the RAN sends the second set of analytics to the MDA.

In some examples, for example as shown in 610, the MDA may determine one or more policies, for example one or more network configuration policies, based on the first and second set of analytics. The MDA may then send the one or more policies to one or more other network entities (e.g. gNBs) accordingly. For example, if the MDA is provided by the OAM, the OAM may disable offloading actions to gNBs whose load exceeds the OAM calculated average load by a threshold value. Furthermore, the OAM may configure an energy saving policy to those gNBs whose energy efficiency is less than a second threshold compared to the energy efficiency prediction calculated by MDAs. In this way MDAs can configure different policies to RAN (gNBs) that depend on how far the local real-time predictions in the RAN are compared to the OAM related ones.

TABLE 1
MDAs/RAN predictions at different intervals and alignment example

| | | | | | | | | | | | | | | | | | | | | | | | | |
|---|---|---|---|---|---|---|---|---|---|---|---|---|---|---|---|---|---|---|---|---|---|---|---|---|
| Example timepoint | | | | | | | | | | | | 1 pm | | | | | | | | | | | | 2 pm |
| time point (interval is | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 |
| 5 minutes) | | | | | | | | | | | | | | | | | | | | | | | | |
| MDAs Prediction1: | — | — | 41 | — | — | 28 | — | — | 36 | — | — | 37 | — | — | 41 | — | — | 36 | — | — | 37 | — | — | 38 |
| 15 m interval | | | | | | | | | | | | | | | | | | | | | | | | |
| MDAs Prediction2: | — | — | — | — | — | — | — | — | — | — | — | 39 | — | — | — | — | — | — | — | — | — | — | — | 39 |
| 1 hour interval | | | | | | | | | | | | | | | | | | | | | | | | |
| RAN prediction: 5 m | 40 | 43 | 39 | 37 | 35 | 38 | 35 | 37 | 38 | 36 | 37 | 37 | 40 | 43 | 42 | 37 | 35 | 38 | 35 | 37 | 38 | 36 | 37 | 37 |
| interval | | | | | | | | | | | | | | | | | | | | | | | | |

Table 1 above shows one example of target PRB usage prediction for one cell during a 2 hour duration with 24 timepoints.

3 predictions are shown. OAM MDA prediction 1 is 15 minute-interval prediction, OAM MDA prediction 2 is 1hour-interval prediction, RAN analytics prediction is 5 minute-interval prediction.

Referring to the example of FIG. 5, MDA Prediction 1 or Prediction 2 may correspond to the first set of analytics, and the RAN prediction may correspond to the second set of analytics. The configuration information sent to the RAN may comprise information indicating that the RAN prediction is to be obtained every five minutes and/or may indicate the time period (12:00-14:00) for which the second set of analytics is to be obtained.

The MDAs Prediction 1 and RAN prediction could be aligned every 15 m and all three predictions could be aligned together every 1 hour. The process of alignment could be done in a similar way if all analytics are statistics instead of predictions as that in table 1.

The threshold may be a calculated value from history statistics of aligned statistics or predictions for each time point in Table 1, e.g., with a set of accumulated 14 days of history data, an Interquartile Range (IQR) could be calculated and used as the threshold for each aligned timepoint.

Based on a different policy, different thresholds could be used, e.g., lower threshold for more sensitive monitoring or Warning level of triggering conditions, higher threshold for major deviation situation with higher level of confidence.

As shown in table 1, for timepoint 6, there is a major deviation of prediction from MDA prediction 1 (28) and RAN prediction (38), which may trigger the RAN to send the analytics to the MDA (i.e. the triggering condition at step 606 may be satisfied).

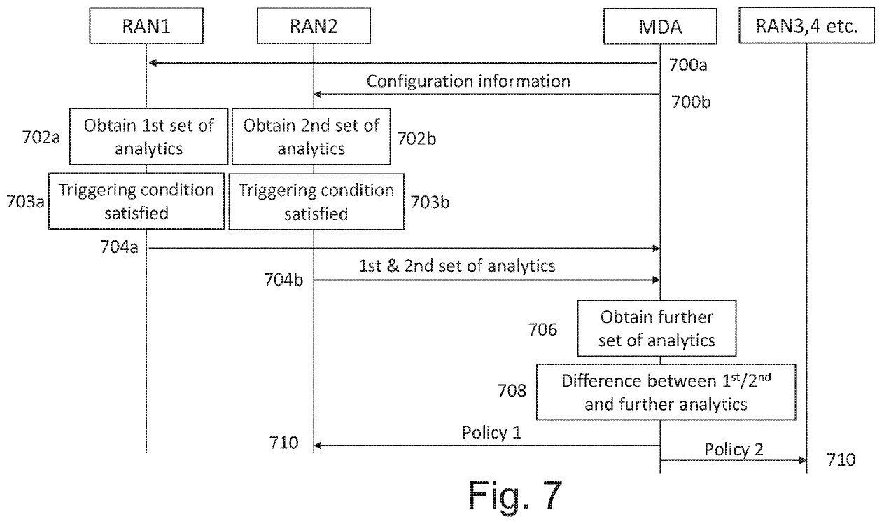

Reference is made to FIG. 7, which shows an example scenario where MDA configures and requests analytics from certain gNBs, and calculates the deviation compared to its own analytics considering also analytics over a neighbourhood of gNBs. This may for example be calculated over a larger area corresponding to a number of gNBs (gNB group), rather than just the two gNBs shown in FIG. 7.

At 700a, the MDA sends configuration information to RAN node RAN1 and at 700b the MDA sends configuration information to RAN node RAN2. The configuration information may be as described previously with respect to FIG. 6. That is to say, in some examples the configuration information may comprise a triggering condition. The triggering condition may be the same for RAN1 and RAN2, or may be different for RAN1 and RAN2.

At 702a, based on the configuration information received at 700a, RAN1 obtains a first set of analytics, and at 702b, based on the configuration information received at 700b, RAN2 obtains a second set of analytics.

At 703a, RAN1 determines that a triggering condition is satisfied. At 703b, RAN2 determines that a triggering condition is satisfied.

At 704a, responsive to determining that the triggering condition is satisfied, RAN1 sends the first set of analytics to the MDA, and at 704b, responsive to determining that the triggering condition is satisfied, RAN2 sends the second set of analytics to the MDA.

It should be understood that steps 700a-704a and steps 700b-704b may be performed substantially in parallel or at different times to each other.

At 706 the MDA determines a further set of analytics based on the first and second sets of analytics received from RAN1 and RAN2 at steps 704a and 704b. For example, the MDA may determine a prediction based on predictions received from RAN1 and RAN2. For instance, the MDA may receive a predicted load for RAN1 and RAN2, and determine an overall predicted network load based on those predictions.

At 708, the MDA determines a difference (e.g. deviation as described previously) between the further set of analytics determined by the MDA at step 706 and each set of analytics received from the RANs at step 704.

In some examples, the MDA may determine whether the further set of analytics and each set of analytics received from the RANs meets a relation condition. That is to say, the MDA may determine whether the difference determined at 708 is above a threshold value, thereby indicating that the differences between the respective sets of analytics are statistically significant.

Based on the determination at 708, at 710 the MDA determines one or more policies, and sends an output to one or more RANs based on the determined policies.

For example, in the case that the analytics output relates to a predicted RAN load, if the deviation in the predicted load among MDA and a given gNB is very low, this may indicate that the load is “uniformly” distributed. Otherwise, if the deviation is very high, this may indicate that the predicted load at a gNB is very different from the predicted load of the other gNBs in the group. Then the MDAS producer can assist in providing a policy to the gNB whose prediction was used in the comparison but also it can recommend a different policy to the rest of the gNBs in the gNB group (e.g. RAN3,4 etc.), even if analytics from those gNBs was not used by the MDA. As a further option, it may decide not to provide a policy to a gNB (e.g., RAN1 in this example).

For example if a set of cells belonging in the gNB group has very high load (and very low deviation with respect to the load prediction of a given gNB), OAM may configure a policy to the gNB not to activate load balancing actions since there is high load in the neighbourhood.

The policy (output) could also indicate to the gNB the reason for this decision, e.g., load in neighbourhood exceeding a threshold. A different policy can be given to the NG-RAN nodes 3, 4 . . . k which form the gNB group based on which MDAs calculated its prediction. In this case those gNBs can be instructed to e.g., activate more cells or to enable a Dual Connectivity mode to try and reduce the load at gNB1 and 2.

In some further examples, the RAN analytics at NG-RAN may request analytics from an MDAS producer. The request may specify a desired area of interest. The area of interest can be calculated at the NG-RAN, considering the mobility of the UEs considered, for example for a particular network slice.

By estimating the speed of UEs and the desired frequency of receiving MDA reports the NG-RAN may provide the area of interest for receiving MDA reports regarding load analytics. This area of interest may change as UEs move.

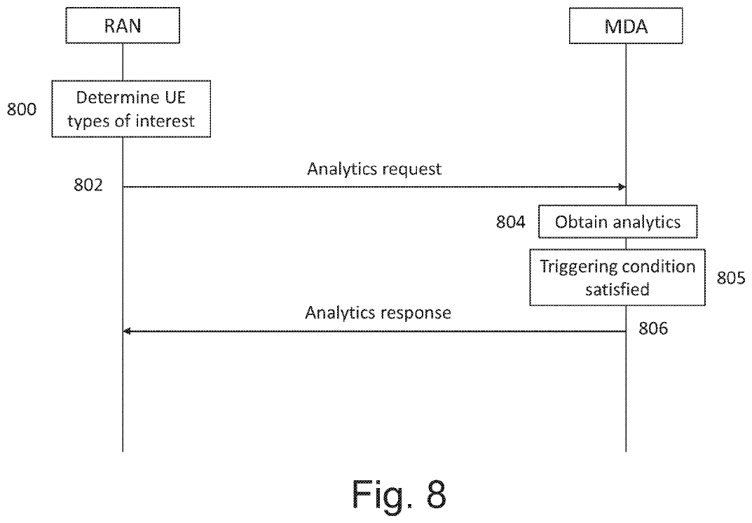

FIG. 8 shows an example signaling exchange that describes this process.

At 800, the RAN determines one or more UE types of interest. For example, the UE types may be determined based on a mobility profile of the UE.

At 802, the RAN sends an analytics request to the MDA. The request may comprise the area scope, prediction period, triggering condition and other predictions enabled as discussed previously.

At 804, the MDA, based on the request received at 802, obtains the requested analytics.

At 805, the MDA determines that the triggering condition is satisfied. The triggering condition may be as discussed previously.

At 806, in response to determining that the triggering condition is satisfied, the MDA sends an analytics response comprising the requested analytics.

As mentioned previously, the mechanisms and sequence diagrams shown in FIGS. 6 to 8 may in some examples also be applied for other cases, such as for the case of MDA and NWDAF as well as for the case of RAN analytics and NWDAF.

For each use case, a MDAS requirement may be provided as follows:

| Requirement | | Related use |
|---|---|---|
| label | Description | case(s) |
| REQ- | MDA capability for “use case x” analysis shall be able to | use case x |
| UCX_MDA-0a | provide a correlation between a prediction provided by | |
| | MDAS and the corresponding prediction obtained by an | |
| | individual gNB (gNB-CU/gNB-CU) | |
| REQ- | MDA capability for “use case x” analysis shall be able to | use case x |
| UCX_MDA-0b | align the analytics between a prediction provided by | |
| | MDAS and the corresponding prediction obtained by an | |
| | individual gNB (gNB-CU/gNB-CU) | |

Therefore, some examples may allow a first data analytics function (such as MDA, OAM, NWDAF) to obtain a set of analytics from a second data analytics function and use the obtained set of analytics in conjunction with a further set of analytics available at the first data analytics function to perform one or more operations to improve network performance. In some examples, the set of analytics may be provided when the deviation between the set and the further set is above a threshold amount, or instead may be provided in response to a request from the first data analytics function. As the first data analytics function is able to receive analytics of different scope in terms of different time scales or different sources of data for the analytics, the decisions for which operations to perform may be enhanced.

In some examples, an apparatus may comprise means for receiving, at a first data analytics function from a second data analytics function, configuration information for obtaining a first set of analytics, wherein the configuration information comprises a triggering condition for reporting the first set of analytics, wherein the first analytics function is configured to utilise a first set of input data for obtaining the first set of analytics and the second analytics function is configured to utilise a second set of input data for obtaining the second set of analytics; based on the configuration information, obtaining the first set of analytics based on the first set of input data; determining that the triggering condition is satisfied; and in response to determining that the triggering condition is satisfied, sending, to the second data analytics function, the first set of analytics.

In some examples, the apparatus may comprise at least one processor and at least one memory including a computer program code, the at least one memory and computer program code configured to, with the at least one processor, cause the apparatus at least to: receive, at a first data analytics function from a second data analytics function, configuration information for obtaining a first set of analytics, wherein the configuration information comprises a triggering condition for reporting the first set of analytics, wherein the first analytics function is configured to utilise a first set of input data for obtaining the first set of analytics and the second analytics function is configured to utilise a second set of input data for obtaining the second set of analytics; based on the configuration information, obtain the first set of analytics based on the first set of input data; determine that the triggering condition is satisfied; and in response to determining that the triggering condition is satisfied, send, to the second data analytics function, the first set of analytics.

In some examples, an apparatus may comprise means for: sending, from a second analytics function to a first data analytics function, configuration information for causing the first data analytics function to obtain a first set of analytics, wherein the configuration information comprises a triggering condition for reporting the first set of analytics, wherein the second analytics function is configured to utilise a second set of input data for obtaining a second set of analytics and the first analytics function is configured to utilise a first set of input data for obtaining the first set of analytics; in response to the triggering condition being satisfied, receiving, from the first data analytics function, the first set of analytics; obtaining a second set of analytics based on the second set of input data; and determining one or more policies based on the first set of analytics and the second set of analytics.

In some examples, the apparatus may comprise at least one processor and at least one memory including a computer program code, the at least one memory and computer program code configured to, with the at least one processor, cause the apparatus at least to: send, from a second analytics function to a first data analytics function, configuration information for causing the first data analytics function to obtain a first set of analytics, wherein the configuration information comprises a triggering condition for reporting the first set of analytics, wherein the second analytics function is configured to utilise a second set of input data for obtaining a second set of analytics and the first analytics function is configured to utilise a first set of input data for obtaining the first set of analytics; in response to the triggering condition being satisfied, receive, from the first data analytics function, the first set of analytics; obtain a second set of analytics based on the second set of input data; and determine one or more policies based on the first set of analytics and the second set of analytics.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1-15. (canceled)

16. An apparatus comprising at least one processor and at least one memory including a computer program code, the at least one memory and computer program code configured to, with the at least one processor, cause the apparatus at least to perform:
receiving, at a first data analytics function from a second data analytics function, configuration information for obtaining a first set of analytics, wherein the configuration information comprises a triggering condition for reporting the first set of analytics, wherein the first analytics function is configured to utilise a first set of input data for obtaining the first set of analytics and the second analytics function is configured to utilise a second set of input data for obtaining the second set of analytics;
based on the configuration information, obtaining the first set of analytics based on the first set of input data;
determining that the triggering condition is satisfied; and
in response to determining that the triggering condition is satisfied, sending, to the second data analytics function, the first set of analytics.

17. The apparatus of claim 16, being further caused to perform:
receiving, from the second data analytics function, the second set of analytics,
wherein determining that a triggering condition is satisfied comprises determining that a difference between the first set of analytics and the second set of analytics is greater than a threshold.

18. The apparatus of claim 17, wherein the difference comprises a deviation value.

19. The apparatus of claim 16, being further caused to perform:
receiving, from the second data analytics function and in response to sending the first set of analytics, one or more policies.

20. The apparatus of claim 16, wherein the configuration information comprises information identifying at least one of:
the first set of analytics;
further analytics related to the first set of analytics;
one or more target objects associated with the first set of analytics;
an area of interest associated with the first set of analytics; and
timing information associated with the first set of analytics.

21. The apparatus claim 16, wherein the first set of analytics comprises a prediction.

22. The apparatus of claim 16, wherein the first data analytics function and/or the second data analytics function comprises one of:
a management data analytics function;
a network data analytics function;
an operations administration and management function; and
a radio data analytics function.

23. An apparatus comprising at least one processor and at least one memory including a computer program code, the at least one memory and computer program code configured to, with the at least one processor, cause the apparatus at least to perform:
sending, from a second analytics function to a first data analytics function, configuration information for causing the first data analytics function to obtain a first set of analytics, wherein the configuration information comprises a triggering condition for reporting the first set of analytics, wherein the second analytics function is configured to utilise a second set of input data for obtaining a second set of analytics and the first analytics function is configured to utilise a first set of input data for obtaining the first set of analytics;
in response to the triggering condition being satisfied, receiving, from the first data analytics function, the first set of analytics;
obtaining a second set of analytics based on the second set of input data; and
determining one or more policies based on the first set of analytics and the second set of analytics.

24. The apparatus of claim 23, being further caused to perform:
sending, to the first data analytics function, the second set of analytics when sending the configuration information,
wherein the triggering condition comprises that a difference between the first set of analytics and the second set of analytics is greater than a threshold.

25. The apparatus of claim 23, wherein obtaining the second set of analytics is further based on the first set of analytics.

26. The apparatus of claim 25, being further caused to perform:
determining that a difference between the first set of analytics and the second set of analytics is greater than a threshold; and
determining the one or more policies in response to determining that the difference between the first set of analytics and the second set of analytics is greater than the threshold.

27. The apparatus of claim 23, wherein the configuration information comprises information identifying at least one of:
the first set of analytics;
further analytics related to the first set of analytics;
one or more target objects associated with the first set of analytics;
an area of interest associated with the first set of analytics; and
timing information associated with the first set of analytics.

28. The apparatus of claim 23, wherein the first set of analytics comprises a prediction.

29. The apparatus of claim 23, wherein the first data analytics function and/or the second data analytics function comprises one of:
a management data analytics function;
a network data analytics function;
an operations administration and management function; and
a radio data analytics function.
